(19) United States
(12) Patent Application Publication
(10) Pub. No.: US 2025/0180049 A1
(43) Pub. Date: Jun. 5, 2025

(54) Retainer with Assembly Prevention and Verification

(71) Applicant: Illinois Tool Works Inc., Glenview, IL (US)

(72) Inventor: Mark A. Beyer, Armada, MI (US)

(21) Appl. No.: 18/955,549

(22) Filed: Nov. 21, 2024

Related U.S. Application Data
(60) Provisional application No. 63/605,650, filed on Dec. 4, 2023.

(51) Int. Cl. F16B 5/06; F16B 21/06

(52) U.S. Cl. CPC F16B 5/0642; F16B 21/065

(57) ABSTRACT

A fastener assembly for coupling a first component to a second component is described. The fastener assembly includes an assembly-verification plunger with a verification head and a pair of spring legs, as well as a retainer with a body portion that defines a retainer opening. The retainer has a pair of retainer legs resiliently connected to the body portion and designed to engage with the opening. Each spring leg includes a lock tab. The verification head features a fixed planar portion and at least one wing portion connected to the fixed planar portion via a hinge. An installation indicator is positioned on at least part of both the fixed planar portion and the wing portion. The retainer opening is configured to receive and secure at least part of the spring legs. Each retainer leg includes a cutout to receive the lock tab, securing the assembly-verification plunger to the retainer in a part-in-assembly (PIA) position.

### RELATED APPLICATION

The present application claims priority to U.S. Provisional Patent Application No. 63/605,650, filed Dec. 4, 2023, which is hereby incorporated by reference in its entirety.

### BACKGROUND

Automotive components require fastening techniques that are simple to manufacture and assemble. Further, fastening techniques should above all be reliable and efficient. In some instances, objects need to be secured to the vehicle to mitigate movement and/or shifting during operation, which can result in damage or kinking to the object. For example, airbags, tubes, hoses, wires, and other objects are often secured to the vehicle components via fasteners. When a fastener is installed incorrectly such that the fastener is not fully inserted into the opening, the fastener can detach and/or the object being fastened can become damaged or loose. Similarly, when an object is attached incorrectly to a fastener, the object can detach from the fastener or become damaged or loose.

In manufacturing and assembly processes, particularly in automotive and structural component assembly, it is essential to ensure that each fastener is correctly positioned and securely fastened. Incorrect installation can lead to misalignment, structural weaknesses, and potential failures. To address these issues, visual inspection or automated systems are often used, but these methods may not ensure complete accuracy. Therefore, there is a need for a fastening system that includes a built-in verification mechanism to confirm secure and correct installation.

Therefore, it would be desirable to provide an installation indicator to enhance proper installation of the fastener assembly and the fastener assembly relative to the components during assembly.

### SUMMARY

The present disclosure relates generally to a fastening system to form a connection between components. More specifically, a fastener with an installation indicator to enhance proper installation of the fastener assembly and the fastener assembly relative to the components during assembly, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a perspective assembly view of the fastening system with a fastener assembly in accordance with aspects of this disclosure.

FIG. 1b illustrates a perspective view of the fastening system in a first (partially assembled) position.

FIGS. 1c and 1d illustrate first and second perspective assembly views of the fastener assembly.

FIGS. 1e through 1h illustrate first, second, third, and fourth side assembly views of the fastener assembly.

FIG. 2a illustrates a perspective front view of the fastener assembly in the first position with a load plate.

FIG. 2b illustrates a perspective view of the fastener assembly in the first position with a load plate.

FIG. 2c illustrates a perspective views of the fastening system with a load plate.

FIG. 2d illustrates a cross-sectional side view of the fastening system (without the load plate) along cut line A-A (FIG. 1b) in the first position.

FIG. 2e illustrates a cross-sectional perspective view of the fastening system along cut line A-A (FIG. 1b) in the second position.

FIGS. 3a and 3b illustrate, respectively, assembly and assembled isometric views of the fastener assembly with the components and a verification system.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “processor” means processing devices, apparatuses, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general-purpose microprocessor or microcontroller, a digital signal processing (DSP) processor, an application-specific integrated circuit (ASIC). The processor may be coupled to or integrated with a memory device. The memory device can be any suitable type of computer memory or any other type of electronic storage medium, such as, for example, read-only memory (ROM), random access memory (RAM), cache memory, compact disc read-only memory (CD-ROM), electro-optical memory, magneto-optical memory, programmable read-only memory (PROM), erasable programmable read-only memory (EPROM), electrically erasable programmable read-only memory (EEPROM), a computer-readable medium, or the like.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The disclosed retainer assembly includes a retainer, an assembly-verification plunger, and, in some cases, a load plate. Notably, the disclosed fastener assembly is configured to join a first component with a first opening and a second component with a second opening that has a different width from the first opening. This configuration helps control the positioning and engagement of the assembly-verification plunger, ensuring it operates correctly when inserted into the second component.

During and after insertion into the first component, the assembly-verification plunger remains securely integrated with the retainer (e.g., as a part in assembly (PIA)); however, once the retainer is installed in the second component by the end user, the assembly-verification plunger can be pressed further into the retainer body. This action compresses the two arched wing portions of the plunger body, activating the assembly-verification feature. With the wing portions flattened, the assembly is then positioned to allow a fiducial marker to be scanned, confirming correct installation and assembly verification.

This retainer assembly offers enhanced redundancy in assembly verification while preventing premature or independent activation of the plunger without proper installation in the intended second component. That is, in some examples the present design ensures that the assembly-verification plunger is not activated unless the retainer is correctly installed, providing a more reliable and fail-safe verification process.

In one example, a fastener assembly for coupling a first component relative to a second component comprises: an assembly-verification plunger having a verification head and a pair of spring legs, wherein each of the pair of spring legs comprises a lock tab, wherein the verification head comprises a fixed planar portion and at least one wing portion coupled to the fixed planar portion via a hinge, and wherein the verification head comprises an installation indicator positioned over at least a portion of each of the fixed planar portion and the at least one wing portion; and a retainer having a body portion that defines a retainer opening and a pair of retainer legs resiliently coupled to the body portion and configured to couple with the opening, wherein the retainer opening is configured to receive and secure at least a portion of the pair of spring legs, and wherein each of the pair of retainer legs comprises a cutout configured to receive the lock tab to secure the assembly-verification plunger relative to the retainer in a part-in-assembly (PIA) position.

In another example, a fastener assembly for coupling a first component relative to a second component comprises: an assembly-verification plunger having a verification head and a pair of spring legs, wherein each of the pair of spring legs comprises a lock tab, and wherein the verification head comprises a fixed planar portion and at least one wing portion coupled to the fixed planar portion via a hinge; and a retainer having a body portion that defines a retainer opening and a pair of retainer legs resiliently coupled to the body portion and configured to couple with the opening, wherein the retainer opening is configured to receive and secure at least a portion of the pair of spring legs, and wherein each of the pair of retainer legs comprises a first cutout configured to receive the lock tab to secure the assembly-verification plunger relative to the retainer in a first position.

In yet another example, a fastener assembly for coupling a first component relative to a second component comprises: an assembly-verification plunger having a verification head and a pair of spring legs, wherein each of the pair of spring legs comprises a lock tab, and wherein the verification head comprises a fixed planar portion and at least one wing portion coupled to the fixed planar portion via a hinge; a retainer having a body portion that defines a retainer opening and a pair of retainer legs resiliently coupled to the body portion and configured to couple with the opening, wherein the retainer opening is configured to receive and secure at least a portion of the pair of spring legs, and wherein each of the pair of retainer legs comprises a cutout configured to receive the lock tab to secure the assembly-verification plunger relative to the retainer in a first position; and a load plate configured to evenly distribute forces over a broader area of the first component, wherein the load plate comprises a plate opening configured to receive the pair of spring legs and the pair of retainer legs.

In some examples, each of the pair of retainer legs comprises an outer planar portion and an inner planar portion connected by a bend section.

In some examples, the inner planar portion comprises the first cutout.

In some examples, each of the pair of retainer legs comprises a second cutout configured to receive the lock tab to secure the assembly-verification plunger relative to the retainer in a second position.

In some examples, the first position is a part-in-assembly (PIA) position and the second position is a fully installed position.

In some examples, the verification head comprises an installation indicator.

In some examples, the installation indicator is a fiducial marker.

In some examples, the verification head comprises a fixed planar portion and at least one wing portion coupled to the fixed planar portion via a hinge.

In some examples, the wing portion is configured to pivot, bend, or move relative to the fixed planar portion.

In some examples, the wing portion is movable between a first position that is transverse to the fixed planar portion and a second position that is in plane with the fixed planar portion.

In some examples, the first position corresponds to a pre-installation position and the second position corresponds to an installed position.

In some examples, the installation indicator is a quick response (QR) code.

In some examples, the retainer is a stamped-metal retainer.

In some examples, the assembly-verification plunger is a plastic component.

In some examples, the fastener assembly further comprises a load plate. For example, the load plate can define a plate opening configured to receive the pair of spring legs and the pair of retainer legs.

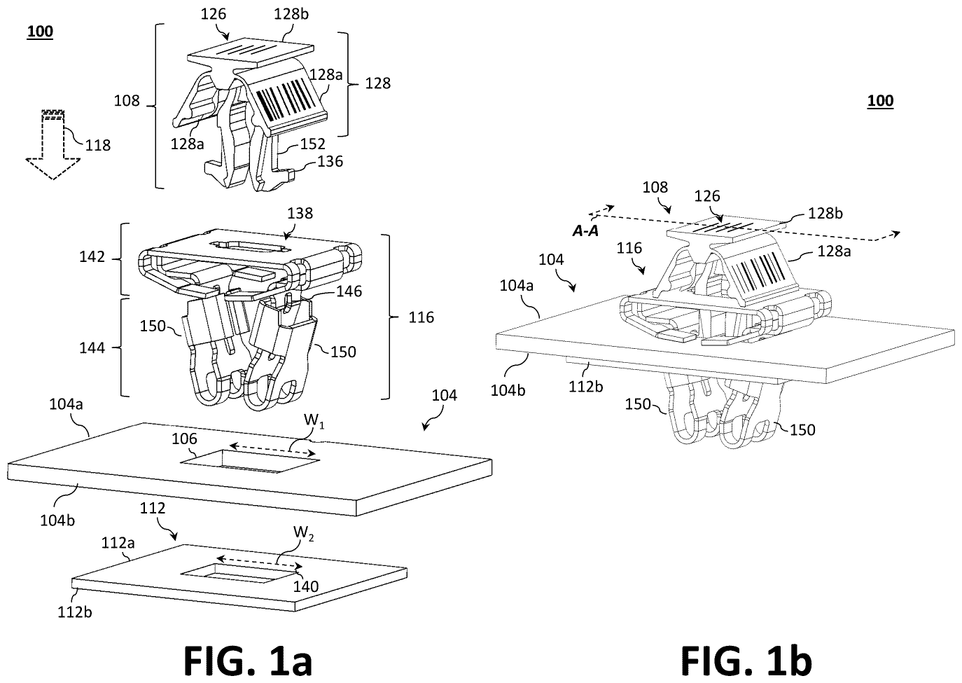

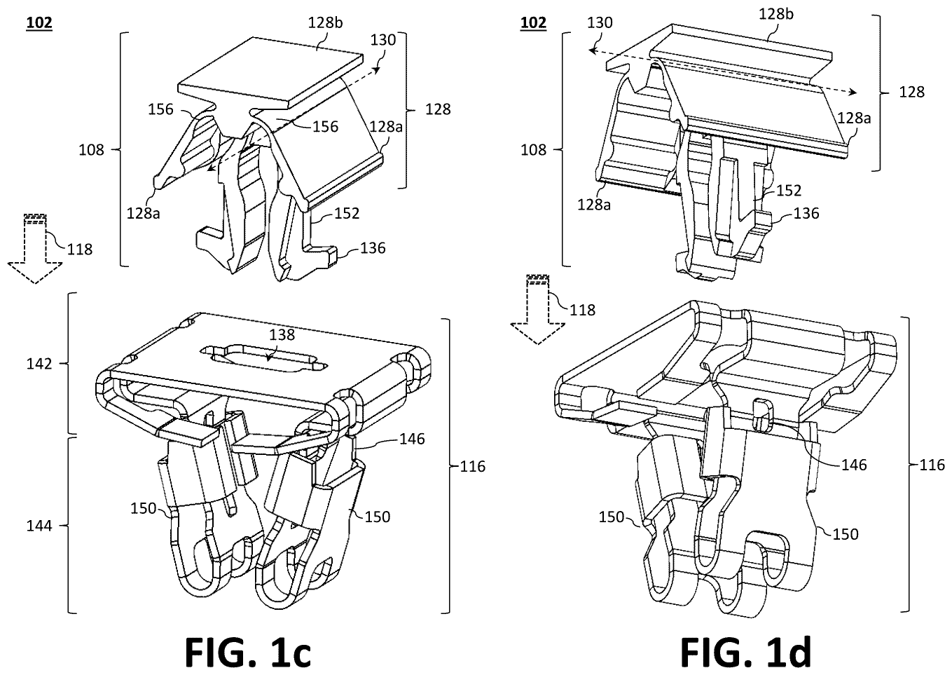

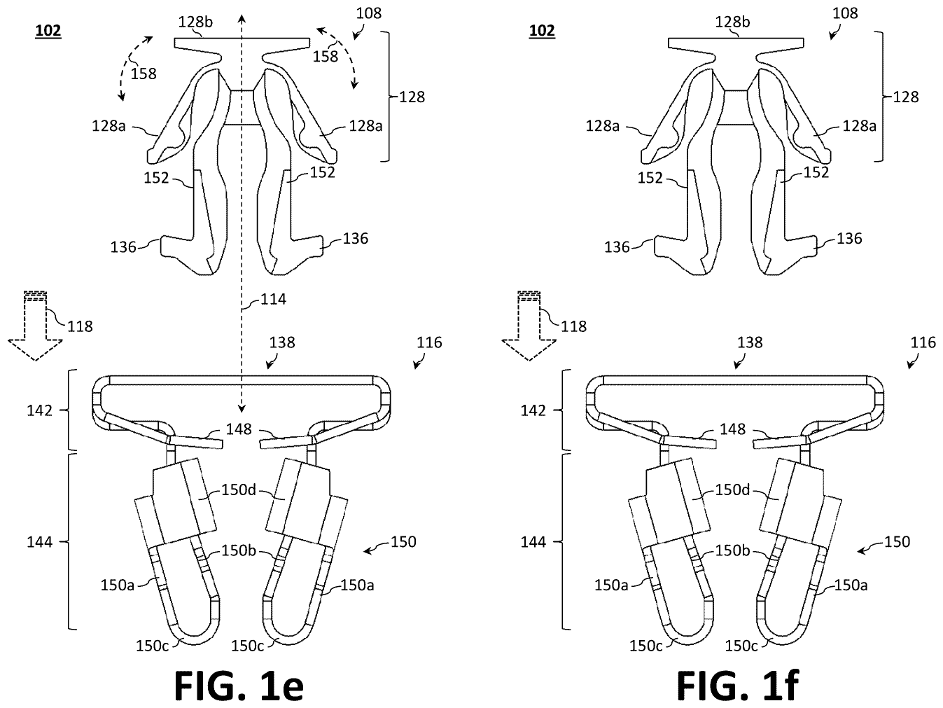

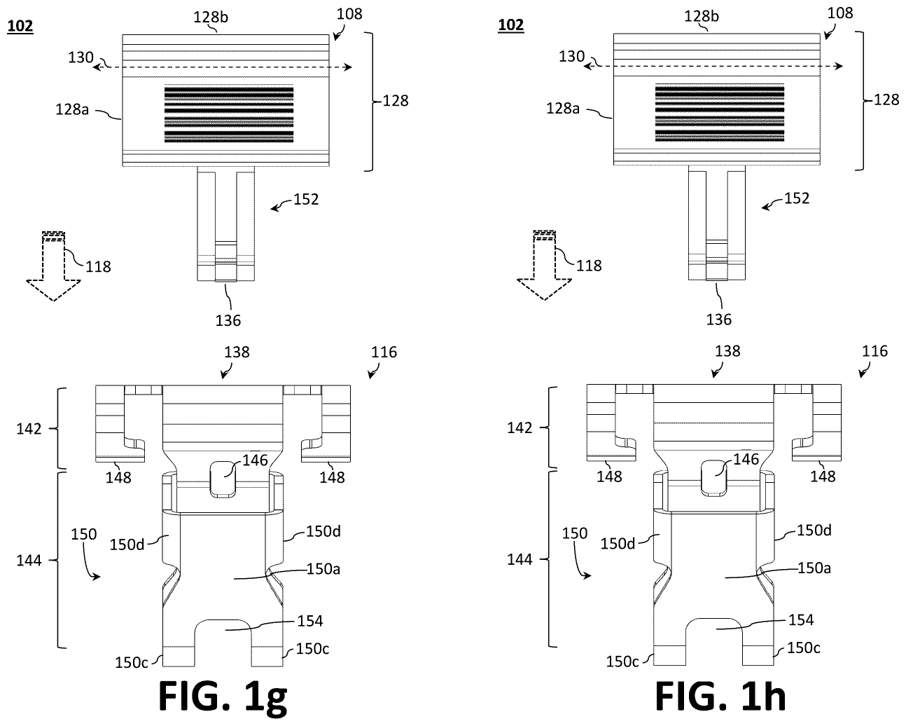

FIGS. 1a through 1h illustrate a fastening system 100 in accordance with aspects of this disclosure that is configured to secure a first component 104 relative to a second component 112 via a fastener assembly 102. FIG. 1a illustrates a perspective assembly view of the fastening system 100 having a fastener assembly 102, while FIG. 1b illustrates a perspective view of the fastening system 100 in a first position (e.g., a shipped position, such as a partially assembled position). FIGS. 1c and 1d illustrate perspective assembly views of the fastener assembly 102, while FIGS. 1e through 1h illustrate first, second, third, and fourth side assembly views of the fastener assembly 102.

The illustrated fastening system 100 generally comprises a fastener assembly 102 for installation in a first component 104 and a second component 112. As illustrated, the fastener assembly 102 generally comprises an assembly-verification plunger 108, a retainer 116, and, in some cases, a load plate 134. The assembly-verification plunger 108 and the retainer 116 of the fastener assembly 102 are configured to engage and securely retain one another, facilitating a reliable connection between the first component 104 and the second component 112. This engagement ensures that the first component 104 and the second component 112 remain properly aligned and connected throughout assembly and installation.

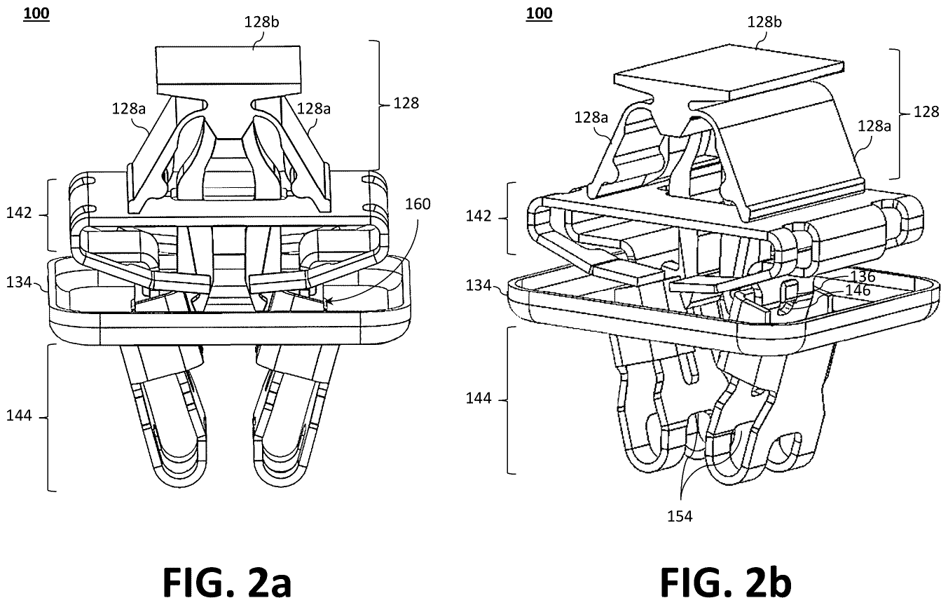

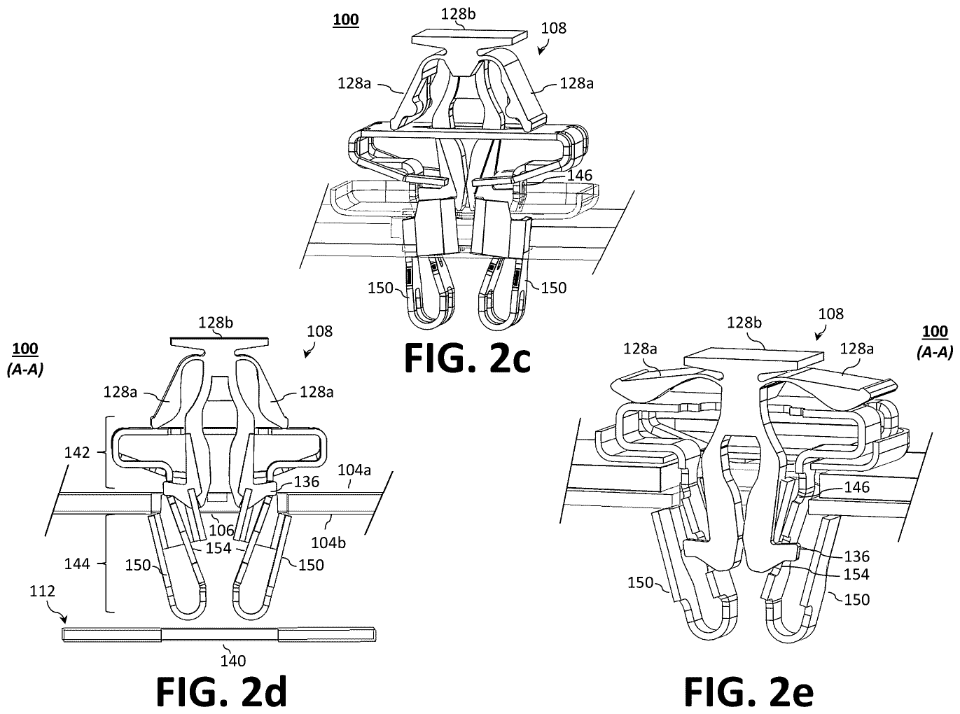

FIGS. 2a and 2b, for example, illustrated front and perspective views of the fastener assembly 102 in the first position having a load plate 134. FIG. 2c illustrates a perspective assembled view of the fastening system 100 in the first position with a load plate 134, while FIG. 2d illustrates a cross-sectional side view of fastening system 100 (with the load plate 134 omitted) taken along cut line A-A (FIG. 1b) in the first position and FIG. 2e illustrates a cross-sectional perspective view of fastening system 100 taken along cut line A-A (FIG. 1b) in a second position (e.g., an installed position, where the assembly-verification plunger 108 is fully and properly seated in the retainer 116).

The first component 104 defines an A-side surface 104a (e.g., a first surface, such as an exterior surface) and a B-side surface 104b (e.g., a second surface, such as an interior surface). The second component 112 similarly defines an A-side surface 112a (e.g., a first surface, such as an exterior surface) and a B-side surface 112b (e.g., a second surface, such as an interior surface). The first component 104 and/or the second component 112 may be, for example, an automotive panel or a structural component of a vehicle, such as doors, pillars (e.g., an A-pillar, B-pillar, C-pillar, etc.), airbags, dashboard components (e.g., a cross member, bracket, frame, etc.), seat frames, center consoles, fenders, sheet metal framework, or the like. Depending on the application, the first component 104 and/or the second component 112 may be fabricated from metal (or a metal alloy), synthetic or semi-synthetic polymers (e.g., plastics such as acrylonitrile butadiene styrene (ABS) and polyvinyl chloride (PVC)), composite materials (e.g., fiberglass), or a combination thereof.

Each of the first component 104 and the second component 112 includes, defines, or otherwise provides one or more openings (e.g., holes or cutouts) formed during the manufacturing of the first component 104 and the second component 112, as applicable. As best illustrated in FIG. 1a, the first component 104 defines a first opening 106 and the second component 112 defines a second opening 140 that are each configured to receive and retain the fastener assembly 102 relative to the first component 104 and the second component 112.

In the illustrated example, the first component 104 provides a first opening 106 as a rectangular hole having a first width (W₁) sized to receive a portion of the fastener assembly 102, while the second component 112 provides a second opening 140 as a rectangular window having a second width (W₂) sized to receive a portion of the fastener assembly 102. With reference to FIG. 1a, the first opening 106 in the first component 104 has a first width (W₁) that is greater than the second width (W₂) of the second opening 140 in the second component 112. This difference in opening widths allows the retainer 116 to be partially assembled within the first component 104 without disengaging the lock tab 136 on the assembly-verification plunger 108. Consequently, the lock tab 136 remains engaged until the retainer 116 is fully installed into the second component 112, ensuring secure retention until final positioning.

The fastener assembly 102 comprises multiple components, including an assembly-verification plunger 108 and a retainer 116, configured to fit together in one or more positions, including the first position and the second position. A load plate 134 may be incorporated to evenly distribute forces over a broader area of the first component 104, thereby mitigating damage. As illustrated, the load plate 134 defines a plate opening 160 configured to receive the pair of spring legs 152 and the pair of retainer legs 150.

The assembly-verification plunger 108 includes a verification head 128 and a pair of spring legs 152. The verification head 128 includes one or more movable wing portions 128a and a fixed planar portion 128b. The spring legs 152 extend generally perpendicular to the verification head 128 and are resiliently connected beneath it. Each spring leg 152 may include one or more lock tabs 136 or similar features configured to engage with the retainer 116 during assembly. In this example, each spring leg 152 includes an outwardly-oriented lock tab 136, i.e., directed away from the central longitudinal axis 114.

The retainer 116 includes a body portion 142 and a perpendicular fastener portion 144. The body portion 142 defines a retainer opening 138, through which the spring legs 152 pass during assembly. The fastener portion 144 includes two retainer legs 150 that are resiliently attached beneath the body portion 142. These retainer legs 150 can flex relative to the central longitudinal axis 114 as the fastener portion 144 is inserted through aligned openings 106, 140 in the first and second components 104 and 112. In some examples, the body portion 142 can include one or more spring tabs 148 configured to contact the first component 104 when installed, thereby mitigating unwanted movements and/or buzz, squeak, and rattle (BSR).

In the illustrated example, each retainer leg 150 comprises of an outer portion 150a and an inner portion 150b connected by a bend section 150c. Each of the outer portion 150a and an inner portion 150b are generally flat, parallel, and spaced to form a gap. Each retainer leg 150 may also include one or more guides 150d, bent at approximately 90 degrees to span the gap between the outer and inner portions.

Each of the pair of retainer legs 150 may define one or more cutouts or other features to interact with the spring legs 152 of the assembly-verification plunger 108 and with the first component 104 adjacent the first opening 106 when fully assembled. In the illustrated example, the inner portion 150b of each of the pair of retainer legs 150 defines a first cutout 146 associated with the first position and a second cutout 154 associated with the second position. The retainer 116 may be fabricated as a single component using a metal stamping process. For example, the retainer 116 can be stamped from a sheet of metal using a die stamping process and then bent to assume the shape of the retainer 116 via one or more bending steps.

With reference to FIG. 2b, the lock tab 136 on the assembly-verification plunger 108 is designed to engage a first cutout 146 formed in the retainer 116, securing the assembly-verification plunger 108 in a first, or initial, position (such as a shipping position, e.g., a part-in-assembly (PIA) position) during transport of the fastener assembly 102 to the end user. This locked position maintains the integrity of the assembly-verification plunger 108, preventing any premature movement or activation prior to final installation.

During installation, with reference to FIG. 2c, as the fastener assembly 102 is inserted into the aligned first opening 106 in the first component 104 and the second opening 140 in the second component 112 as indicated by arrow 118, the inner walls of the retainer compress the spring legs 152 of the assembly-verification plunger 108. This compression causes the lock tab 136 on the assembly-verification plunger 108 to release from the first cutout 146 in the retainer 116, thereby allowing the assembly-verification plunger 108 to shift in the direction indicated by arrow 118, facilitating proper engagement and assembly verification.

This permits the assembly-verification plunger 108 to be pushed into the second position—the final assembled position. Before the assembly-verification plunger 108 is fully installed, the visual quality system 120 cannot read the installation indicator 126 (e.g., assembly verification code, such as a barcode, QR code, etc.) engraved, adhered, or otherwise positioned on the top of the assembly-verification plunger 108 on the fixed planar portion 128b and wing portions 128a. Once the assembly-verification plunger 108 is fully seated, with reference to FIG. 2e, the lock tab 136 on the assembly-verification plunger 108 is designed to engage a second cutout 154 formed in the retainer 116, securing the assembly-verification plunger 108 in the second, or final, position (such as an installed position).

Once installed, the wing portions 128a are bent to a flat position, allowing the visual quality system 120 to read and validate the correct and complete installation. As illustrated, a scannable installation indicator 126, positioned on one or more movable wing portions 128a and a fixed planar portion 128b, becomes readable only when the wing portions 128a are biased upward and compressed. This configuration ensures that the installation indicator 126 is accessible for scanning only after correct installation, confirming that the wings are properly engaged and the fastener assembly 102 is secure.

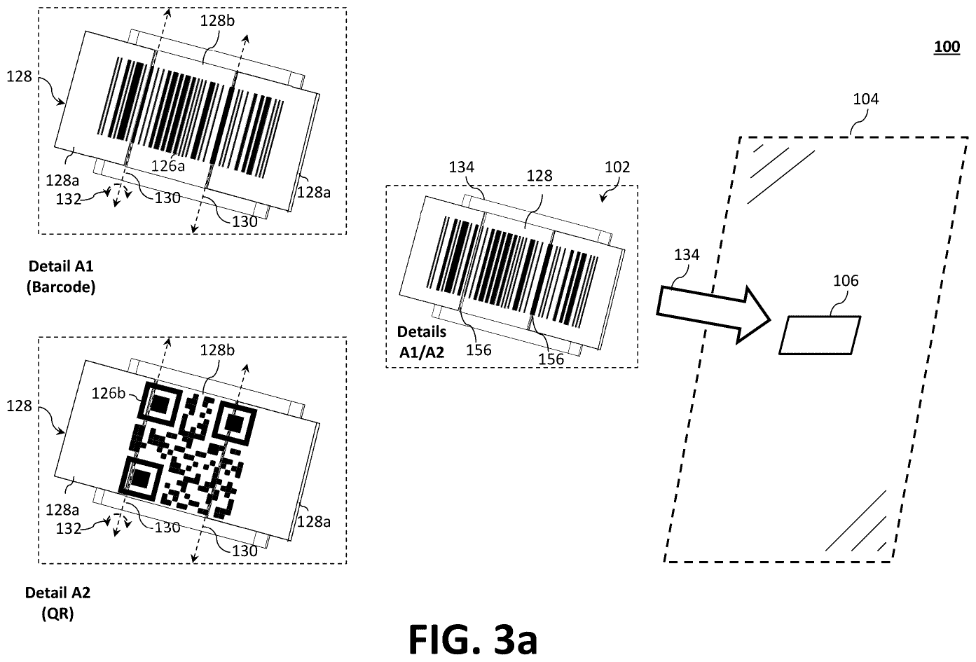

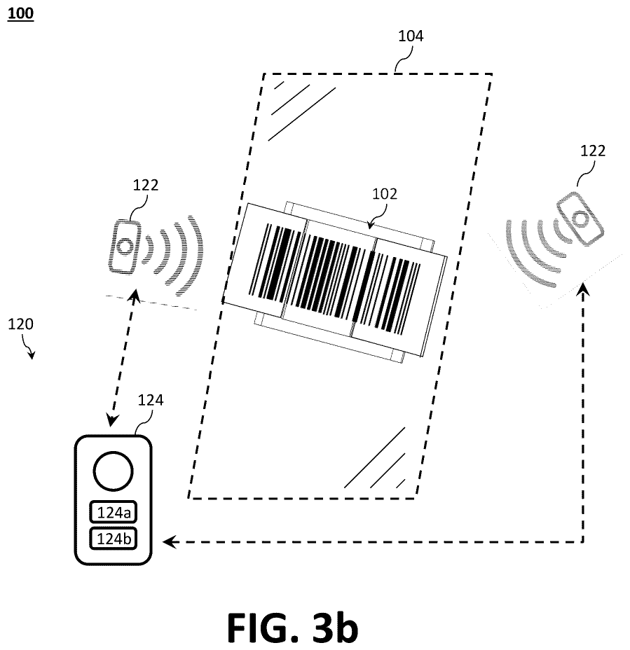

In the illustrated example, to facilitate tracking, the fastener assembly 102 includes an assembly-verification plunger 108 having a head 128 coupled to the spring legs 152. The head 128, in an installed position, defines a generally planar surface that supports and/or provides an installation indicator 126, which can be tracked by a visual quality system 120 (as illustrated and described in FIGS. 3a and 3b) and/or checked manually. When in the fully installed position, the head 128 is a generally flat structure composed of a fixed planar portion 128b (fixed relative to the spring legs 152) and one or more movable wing portions 128a. In the illustrated example, the head 128 comprises a fixed planar portion 128b and two movable wing portions 128a positioned on opposite sides of the fixed planar portion 128b.

The head 128 and/or the installation indicator 126 may be integral with the fastener assembly 102. The head 128 includes or provides the installation indicator 126, which can be a 2-dimensional fiducial marker (e.g., a barcode, quick response (QR) code, AprilTag, etc.) positioned on the wing portions 128a of the head 128. Example barcode 126a and QR code 126b fiducial markers are illustrated in Details A1 and A2 of FIG. 3a. While the head 128 is illustrated as a generally flat structure, other shapes can be used to orient the installation indicator 126 at the appropriate angle relative to the reader 122 when the first component 104 is properly inserted and seated into the first opening 106 of the first component 104 and the second opening 140 of the second component 112. In another example, the installation indicator 126 can be a 3-dimensional fiducial marker formed on the head 128.

To facilitate movement, the head 128 includes or defines one or more hinges 156 that allow the wing portions 128a to pivot, bend, or move relative to the fixed planar portion 128b of the head 128 about a pivot axis 130 as indicated by arrows 132. In one example, the wing portions 128a are configured to pivot about the pivot axis 130 between a first position (e.g., a shipped position, such as a partially assembled position) and a second position (e.g., an installed position, where the assembly-verification plunger 108 is properly seated in the retainer 116).

When the assembly-verification plunger 108 is properly inserted into the retainer 116, the retainer 116 causes the wing portions 128a of the assembly-verification plunger 108 to pivot about the pivot axis 130 to assume a second position. When the assembly-verification plunger 108 is inserted into the retainer 116 improperly (or another anomaly occurs), the head 128 would assume a third position (e.g., an intermediate position between the first and second positions, such as another non-planar position).

With reference to FIG. 3a, a first section of the installation indicator 126 is arranged on the fixed planar portion 128b of the head 128. To the right and to the left of the fixed planar portion 128b, a wing portion 128a in the form of a curved plate is connected to the fixed planar portion 128b by means of a film hinge 156 as in the first embodiment. Each of the two wing portions 128a carries a further section of the installation indicator 126. In the first position of the wing portions 128a, the wing portions 128a hang down at an angle such that the installation indicator 126 cannot be read by a visual quality system 120. Once the head 128 has assumed its final, fully seated mounting position after the push-in process in the direction indicated by arrow 118, with the two wing portions 128a having been swiveled as indicated by arrows 158 relative to the fixed planar portion 128b due to contact with portions of the retainer 116, the fixed planar portion 128b and the two wing portions 128a are in a single plane or parallel planes. The installation indicator 126 can now be read by the visual quality system 120.

The components of the fastener assembly 102 may be formed as a unitary structure. For example, the assembly-verification plunger 108 can each be fabricated via mold tooling and a plastic-injection molding process. In another example, the assembly-verification plunger 108 can be a printed thermoplastic material component that can be printed with great accuracy and with numerous details, which is particularly advantageous for creating components requiring complex and/or precise features. Additive manufacturing techniques obviate the need for mold tooling typically associated with plastic injection molding, thereby lowering up-front manufacturing costs, which is particularly advantageous in low-volume productions. In some examples, the fastener assembly 102 may be fabricated using material extrusion (e.g., fused deposition modeling (FDM), stereolithography (SLA), selective laser sintering (SLS), material jetting, binder jetting, powder bed fusion, directed energy deposition, VAT photopolymerization, and/or any other suitable type of additive manufacturing/3D printing process).

Additive manufacturing techniques print objects in three dimensions, therefore both the minimum feature size (i.e., resolution) of the X-Y plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (DPI) or micrometers (μm). The particles (3D dots) in the horizontal resolution can be around 50 to 100 μm (510 to 250 DPI) in diameter.

Typical layer thickness (vertical resolution) is around 100 μm (250 DPI), although the layers may be as thin as 16 μm (1,600 DPI). The smaller the particles, the higher the horizontal resolution (i.e., higher the details the printer produces). Similarly, the smaller the layer thickness in Z-axis, the higher the vertical resolution (i.e., the smoother the printed surface will be). A printing process in a higher vertical resolution printing, however, will take longer to produce finer layers as the printer has to produce more layers. In some examples, the fastener assembly 102 may be formed or otherwise fabricated at different resolutions during a printing operation.

FIGS. 3a and 3b illustrate, respectively, assembly and assembled isometric views of the fastener assembly 102 with the first component 104, the second component 112, and a verification system. As illustrated, the fastening system 100 can be used with a visual quality system 120 having a reader 122 and a computer 124. The visual quality system 120 (or a component thereof) can be positioned adjacent to the fastener assembly 102 and/or first component 104 to monitor the assembly of the fastener assembly 102 with the first component 104 and/or the second component 112. In the illustrated example, the visual quality system 120 includes, inter alia, a reader 122 communicatively coupled to a computer 124. The reader 122 can be communicatively coupled to the computer 124 via a wired or wireless link. The reader 122 is arranged to image or otherwise track the installation indicator 126 associated with the fastener assembly 102.

In some examples, the head 128 is designed such that the one or more installation indicators 126 are not visible to the visual quality system 120 until the assembly-verification plunger 108 is fully assembled. That is, when the assembly-verification plunger 108 is properly seated in the retainer 116 and/or the fastener assembly 102 is properly seated into the first opening 106 of the first component 104. For example, if an assembly-verification plunger 108 is not fully inserted, the head 128 will not assume the second position (e.g., the wing portions 128a will not be planar with the fixed planar portion 128b) and the visual quality system 120 would either not detect the installation indicators 126 or determine that the angle is incorrect. In either case, the visual quality system 120 would indicate an error or anomaly.

If the computer 124, via one or more processors 124a coupled to a memory device 124b, determines based at least in part on the one or more installation indicators 126 that the fastener assembly 102 is not properly mounted to the first component 104 an alert may be communicated to the operator (e.g., via a portable communication device) and/or, if robotic assembly is employed, the robot may automatically repeat the assembly process to correct the error.

While one installation indicator 126 is illustrated, additional or fewer installation indicators 126 can be employed and associated with the fastener assembly 102 during installation. Further, additional installation indicators 126 can be formed in or on the fastener assembly 102 to provide redundancy and/or increase accuracy by having multiple positional data points. In some examples, in addition to or in lieu of the head 128, one or more installation indicators 126 can be positioned on another portion of the body portion 142 (e.g., a sidewall thereof).

The installation indicator 126 is coupled to the head 128. The installation indicator 126 can be printed on the head 128 directly, applied as a sticker, or otherwise affixed. The wing portions 128a are coupled to the fixed planar portion 128b of the head 128 via hinges 156. The wing portions 128a are configured to pivot between the first position and the second position. Specifically, the head 128 assumes the second position when the assembly-verification plunger 108 is properly seated into the tube retainer 116 of the body portion 142. The reader 122, which is separate from the fastener assembly 102 and operatively coupled to a computer, is configured, via the processor 124a, to track the installation indicator 126 during the installation of the tube 110 or the fastener assembly 102.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A fastener assembly for coupling a first component relative to a second component, the fastener assembly comprising:
an assembly-verification plunger having a verification head and a pair of spring legs,
wherein each of the pair of spring legs comprises a lock tab,
wherein the verification head comprises a fixed planar portion and at least one wing portion coupled to the fixed planar portion via a hinge, and
wherein the verification head comprises an installation indicator positioned over at least a portion of each of the fixed planar portion and the at least one wing portion; and
a retainer having a body portion that defines a retainer opening and a pair of retainer legs resiliently coupled to the body portion and configured to couple with the opening,
wherein the retainer opening is configured to receive and secure at least a portion of the pair of spring legs, and
wherein each of the pair of retainer legs comprises a cutout configured to receive the lock tab to secure the assembly-verification plunger relative to the retainer in a part-in-assembly (PIA) position.

2. A fastener assembly for coupling a first component relative to a second component, the fastener assembly comprising:
an assembly-verification plunger having a verification head and a pair of spring legs,
wherein each of the pair of spring legs comprises a lock tab, and
wherein the verification head comprises a fixed planar portion and at least one wing portion coupled to the fixed planar portion via a hinge; and
a retainer having a body portion that defines a retainer opening and a pair of retainer legs resiliently coupled to the body portion and configured to couple with the opening,
wherein the retainer opening is configured to receive and secure at least a portion of the pair of spring legs, and
wherein each of the pair of retainer legs comprises a first cutout configured to receive the lock tab to secure the assembly-verification plunger relative to the retainer in a first position.

3. The fastener assembly of claim 2, wherein each of the pair of retainer legs comprises an outer planar portion and an inner planar portion connected by a bend section.

4. The fastener assembly of claim 3, wherein the inner planar portion comprises the first cutout.

5. The fastener assembly of claim 2, wherein each of the pair of retainer legs comprises a second cutout configured to receive the lock tab to secure the assembly-verification plunger relative to the retainer in a second position.

6. The fastener assembly of claim 5, wherein the first position is a part-in-assembly (PIA) position and the second position is a fully installed position.

7. The fastener assembly of claim 2, wherein the verification head comprises an installation indicator.

8. The fastener assembly of claim 7, wherein the installation indicator is a fiducial marker.

9. The fastener assembly of claim 7, wherein the verification head comprises a fixed planar portion and at least one wing portion coupled to the fixed planar portion via a hinge.

10. The fastener assembly of claim 9, wherein the wing portion is configured to pivot, bend, or move relative to the fixed planar portion.

11. The fastener assembly of claim 10, wherein the wing portion is movable between a first position that is transverse to the fixed planar portion and a second position that is in plane with the fixed planar portion.

12. The fastener assembly of claim 11, wherein the first position corresponds to a pre-installation position and the second position corresponds to an installed position.

13. The fastener assembly of claim 7, wherein the installation indicator is a quick response (QR) code.

14. The fastener assembly of claim 2, wherein the retainer is a stamped-metal retainer.

15. The fastener assembly of claim 2, wherein the assembly-verification plunger is a plastic component.

16. The fastener assembly of claim 2, further comprising a load plate.

17. The fastener assembly of claim 16, wherein the load plate defines a plate opening configured to receive the pair of spring legs and the pair of retainer legs.

18. A fastener assembly for coupling a first component relative to a second component, the fastener assembly comprising:
an assembly-verification plunger having a verification head and a pair of spring legs,
wherein each of the pair of spring legs comprises a lock tab, and
wherein the verification head comprises a fixed planar portion and at least one wing portion coupled to the fixed planar portion via a hinge;
a retainer having a body portion that defines a retainer opening and a pair of retainer legs resiliently coupled to the body portion and configured to couple with the opening,
wherein the retainer opening is configured to receive and secure at least a portion of the pair of spring legs, and
wherein each of the pair of retainer legs comprises a cutout configured to receive the lock tab to secure the assembly-verification plunger relative to the retainer in a first position; and
a load plate configured to evenly distribute forces over a broader area of the first component, wherein the load plate comprises a plate opening configured to receive the pair of spring legs and the pair of retainer legs.
